(19) United States
(12) Patent Application Publication
(10) Pub. No.: US 2015/0086727 A1
(43) Pub. Date: Mar. 26, 2015

(54) PREPARING METHOD OF CATALYST FOR FUEL CELL AND PREPARING METHOD OF MEMBRANE ELECTRODE ASSEMBLY

(71) Applicant: National Taiwan University of Science and Technology, Taipei (TW)

(72) Inventors: Chen-Hao Wang, New Taipei City (TW); Sun-Tang Chang, Taoyuan County (TW); Hsiao-Chien Wang, Tainan City (TW)

(73) Assignee: National Taiwan University of Science and Technology, Taipei (TW)

(21) Appl. No.: 14/225,462

(22) Filed: Mar. 26, 2014

(30) Foreign Application Priority Data
Sep. 26, 2013 (TW) 102134840

(51) Int. Cl. H01M 4/88; H01M 8/10; H01M 8/22

(52) U.S. Cl. CPC H01M 4/8828; H01M 8/222; H01M 4/8878; H01M 8/1004
USPC 427/553; 502/5

(57) ABSTRACT

A preparing method of a catalyst for a fuel cell includes mixing a nitrogen-containing compound, a metal-containing compound, a carbon support, and a solvent to form a first composition, so that the nitrogen-containing compound and the metal-containing compound are dispersed in the solvent; removing the solvent of the first composition to form a second composition; performing a microwave process on the second composition.

### CROSS-REFERENCE TO RELATED APPLICATION

This application claims the priority benefit of Taiwan application serial no. 102134840, filed on Sep. 26, 2013. The entirety of the above-mentioned patent application is hereby incorporated by reference herein and made a part of this specification.

### BACKGROUND OF THE INVENTION

1. Field of the Invention

The invention generally relates to a preparing method of a catalyst, and in particular, to a preparing method of a catalyst for a fuel cell.

2. Description of Related Art

A fuel cell is basically an electrochemical power generating device that converts chemical energy into electric energy through a redox reaction. In a common proton exchange membrane fuel cell (PEMFC), methanol or hydrogen undergoes an oxidation reaction at the anode, and oxygen undergoes an oxygen reduction reaction (ORR) at the cathode. Generally, the reduction reaction at the cathode is slower than the oxidation reaction at the anode, and therefore a noble metal (such as Pt) is used as a cathode catalyst to accelerate the reduction reaction. Moreover, a conventional cathode catalyst is usually synthesized by mixing an organic material and a precursor of a noble metal and performing a pyrolysis process at a temperature of 300° C. to 1200° C. for 4 hours to 8 hours. Therefore, the synthesis of the cathode catalyst requires a considerable amount of time and energy. On the other hand, the synthesis of the cathode catalyst usually requires a toxic solvent which causes environmental pollution, such as dimethylformamide (DMF) or chloroform, and therefore the synthesis of the cathode catalyst is very environmentally-unfriendly.

Conventional catalysts for fuel cells are catalysts with higher costs, such as a Pt/C catalyst, a pyrolyzed vitamin B 12/carbon catalyst as published in Energy Environ. Sci., 2012, 5, 5305-5314 by Chen et al., a pyrolyzed cobalt tetramethoxyphenyl porphyrin (II)/carbon catalyst as published in Energy Environ. Sci., 2012, 5, 5305-5314 by Chen et al., a pyrolyzed cobalt/carbon and a pyrolyzed iron phthalocyanine catalyst, or a pyrolyzed cobalt-Corrole/carbon catalyst as published in Adv. Funct. Mater. 2012, 22, 3500-3508 by Chen et al. Thus, how to develop a catalyst for s fuel cell without significantly increasing the fabrication costs has become a focus of concern of people having ordinary skill in the art.

### SUMMARY OF THE INVENTION

Therefore, the invention provides a catalyst for a fuel cell, and the catalyst is low in cost and can facilitate the cathode reduction reaction of the fuel cell.

An embodiment of the invention provides a preparing method of a catalyst for a fuel cell, and the preparing method includes steps as follows. A nitrogen-containing compound, a metal-containing compound, a carbon support, and a solvent are mixed to form a first composition, so that the nitrogen-containing compound and the metal-containing compound are dispersed in the solvent. The solvent in the first composition is removed to form a second composition, and a microwave process is performed on the second composition.

In an embodiment of the invention, the nitrogen-containing compound includes urea, uric acid, or a combination thereof.

In an embodiment of the invention, the metal-containing compound includes an iron-containing compound, a cobalt-containing compound, or a combination thereof.

In an embodiment of the invention, the carbon support includes a carbon nanotube, a carbon black or graphene, or a combination thereof.

In an embodiment of the invention, the solvent includes an alcohol solvent, water, or a combination thereof.

In an embodiment of the invention, the step of performing the microwave process on the second composition includes putting the second composition in a container, coating the container with a cladding material, and performing the microwave process on the second composition. Here, the cladding material is not in contact with the second composition.

An embodiment of the invention further provides a preparing method of a membrane electrode assembly for a fuel cell, and the preparing method includes following steps. A polymer membrane having proton conductivity is provided and a cathode catalyst layer and an anode catalyst layer are formed at two sides of the polymer membrane, respectively. A diffusion layer is formed on the cathode catalyst layer and the anode catalyst layer, respectively. Note that a preparing method of the cathode catalyst layer includes mixing a nitrogen-containing compound, a metal-containing compound, a carbon support, and a solvent to form a first composition, so that the nitrogen-containing compound and the metal-containing compound are dispersed in the solvent; removing the solvent in the first composition to form a second composition; performing a microwave process on the second composition.

Based on the above, in an embodiment of the invention, the first composition is formed by mixing the nitrogen-containing compound (e.g., urea and/or uric acid), the metal-containing compound (e.g., the iron-containing compound and/or the cobalt containing compound, the carbon support, and the solvent. Moreover, in an embodiment of the invention, the microwave process is performed on the second composition (obtained by removing the solvent from the first composition) to foini the catalyst. As a result, the raw material costs of synthesizing the catalyst can be lowered down significantly, the time for synthesizing the catalyst for the fuel cell can be shortened, and the ratio of the composition can be more readily controlled.

To make the above features and advantages of the invention more comprehensible, several embodiments are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a device configured for performing a microwave process according to an embodiment of the invention.

FIG. 2 is a schematic diagram of a fuel cell membrane electrode assembly according to an embodiment of the invention.

FIG. 3A illustrates an X-ray absorption near edge spectrum of an iron-urea-carbon catalyst synthesized by performing a microwave process for different periods of time.

FIG. 3B illustrates an extended X-ray absorption fine structure spectrum of an iron-urea-carbon catalyst synthesized by performing a microwave process for different periods of time.

FIG. 4 is an X-ray powder diffraction spectrum of an iron-urea-carbon catalyst, urea, and ferric nitrate synthesized by performing a microwave process for different periods of time.

FIG. 5 is a diagram illustrating oxygen reduction ability of an iron-urea-carbon catalyst synthesized by performing a microwave process for different periods of time.

FIG. 6 is a polarization curve diagram illustrating that an iron-urea-carbon catalyst synthesized by performing a microwave process for different periods of time is applied as a cathode catalyst of a proton exchange membrane fuel cell (PEMFC).

FIG. 7 is a polarization curve diagram illustrating that an iron-urea-carbon catalyst, an iron-urea-uric acid-carbon catalyst, and an iron-uric acid-carbon catalyst are applied as a cathode catalyst of a PEMFC, and the iron-urea-carbon catalyst, the iron-urea-uric acid-carbon catalyst, and the iron-uric acid-carbon catalyst are synthesized at different weight ratios of urea and uric acid.

FIG. 8 is a polarization curve diagram illustrating that an iron-urea-uric acid-carbon catalyst, a cobalt-urea-uric acid-carbon catalyst, and an iron-cobalt-urea-uric acid-carbon catalyst are applied as a cathode catalyst of a PEMFC, and the iron-urea-uric acid-carbon catalyst, the cobalt-urea-uric acid-carbon catalyst, and the iron-cobalt-urea-uric acid-carbon catalyst are synthesized at different weight ratios of iron and cobalt.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The Preparing Method of a Catalyst for a Fuel Cell May Include Steps as Follows:

(a) mixing a nitrogen-containing compound, a metal-containing compound, a carbon support, and a solvent to form a first composition, so that the nitrogen-containing compound and the metal-containing compound are dispersed in the solvent; (b) removing the solvent in the first composition to form a second composition; and (c) performing a microwave process on the second composition. Each step described above will be described more precisely hereinafter.

Step (a):

step (a) can be performed by any conventional mixing method, so that the nitrogen-containing compound and the metal-containing compound are dispersed in the solvent. Here, the term “disperse” means that the nitrogen-containing compound and the metal-containing compound are substantially uniformly dispersed in the solvent. For instance, the step (a) is performed by stirring with a magnetic stirrer (i.e., a combination of a magnetic stirrer and a stir bar), by stirring with a mechanical stirrer, and by a sonication with a sonicator, which may be done individually or together. In addition, the step (a) is preferably performed by sonication with the sonicator, which allows the nitrogen-containing compound and the metal-containing compound to be dispersed in the solvent more uniformly.

The nitrogen-containing compound includes urea, uric acid, or a combination thereof. It should be mentioned that the price of urea and the price of uric acid are cheaper, and thus the raw material cost of the catalyst can be reduced efficiently. When the nitrogen-containing compound includes urea or uric acid, the weight ratio of urea to the carbon support can be 1:5 to 5:1. In addition, the weight ratio of uric acid to the carbon support can be 1:5 to 5:1. Besides, when the nitrogen-containing compound is composed of urea and uric acid, the weight ratio of urea and uric acid can be 0:1 to 1:0, and preferably 2:1.

The metal-containing compound includes an iron-containing compound, a cobalt-containing compound, or a combination thereof. The iron-containing compound (i.e., a precursor of ferrous (III) ion) generally refers to any compound that can generate ferrous ions. Specifically, the iron-containing compound includes ferric nitrate, potassium ferricyanide, ferric chloride, ferric sulfate, iron fluoride, ferric bromide, iron oxide, or a combination thereof. The cobalt-containing compound (i.e., a precursor of cobalt (III) ion) generally refers to a compound that can generate cobalt ions. Specifically, the cobalt-containing compound includes cobalt nitrate, cobalt bromide, cobalt iodide, cobalt chloride, cobalt oxide, cobalt sulfate, cobalt phosphate, or a combination thereof. It should be mentioned that the price of the iron-containing compound and the price of the cobalt-containing compound are relatively low, and thus the raw material cost of the catalyst can be reduced efficiently. When the metal-containing compound includes an iron-containing compound or a cobalt-containing compound, the weight ratio of the metal-containing compound to the carbon support can be 1:5 to 5:1. While the metal-containing compound is composed of an iron-containing compound and a cobalt-containing compound, the atom ratio of iron to cobalt can be 0:1 to 1:0, and preferably 2:1. While the metal-containing compound includes an iron-containing compound or a cobalt-containing compound, the weight ratio of the metal-containing compound to the nitrogen-containing compound can be 1:5 to 5:1, and preferably 1:5.

The carbon support includes graphite, carbon clothes, fullerene, graphene, carbon nanotubes (CNTs), or a combination thereof.

The solvent generally refers to a solvent that can dissolve a nitrogen-containing compound and a metal-containing compound but does not react with the nitrogen-containing compound and the metal-containing compound. Besides, the solvent includes an environmentally-friendly solvent, such as an alcohol solvent or water. Specific examples of the alcohol solvent include alcohols or glycols, the alcohols include methanol, ethanol, n-propanol, isopropanol, n-butanol, sec-butanol, tert-butanol, isobutyl alcohol, n-hexanol, n-heptanol, n-octanol, and n-decanol, and the glycols include ethylene glycol, diethylene glycol, and triglycol. Said solvents can be used individually or may be combined and used. The solvent is preferably ethanol, water, or a combination thereof.

Step (b):

the solvent in the first composition can be removed by any conventional way of removing the solvent in order to form a second composition (obtained by removing the solvent from the first composition). Specifically, the solvent is, for instance, removed by reduced pressure concentration. In step (a), the nitrogen-containing compound and the metal-containing compound are dispersed in the solvent, and thus the nitrogen-containing compound and the metal-containing compound can be substantially dispersed on the carbon support uniformly after the solvent is removed from the first composition.

Step (c):

the step of performing a microwave process on the second composition includes a step (c1) of installing a device for performing the microwave process and a step (c2) of performing the microwave process on the second composition.

Step (c1):

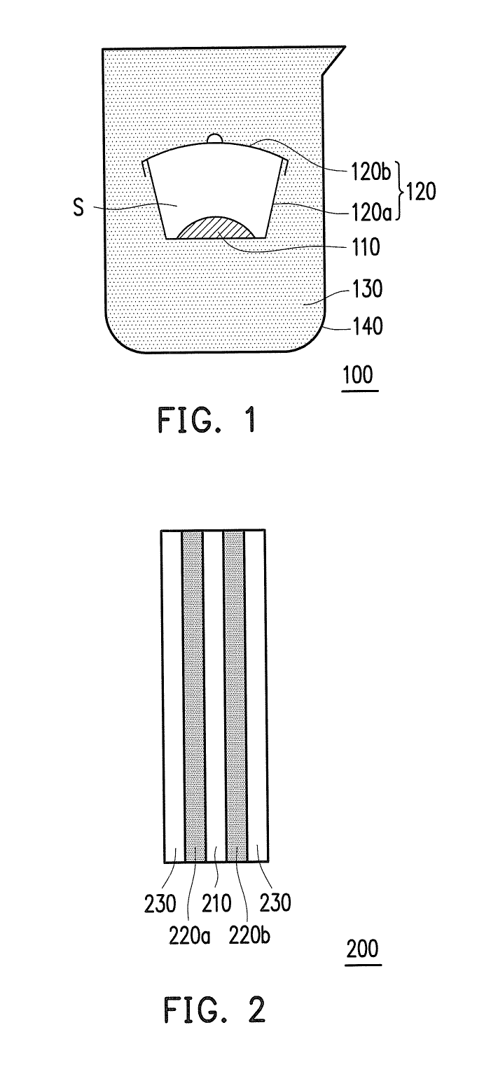

FIG. 1 is a schematic diagram of a device configured for performing a microwave process according to an embodiment of the invention. As shown in FIG. 1, the device 100 for performing the microwave process includes a first container 120 configured for loading the second composition 110, a cladding material 130, and a second container 140. Besides, the method of installing the device 100 for performing the microwave process is described below. The second composition 110 is put in the first container 120, wherein the first container 120 is, for instance, a crucible, such as an alumina crucible or a ceramic crucible. In the embodiment, the first container 120 is a crucible 120. The crucible 120 includes a crucible body 120a and a crucible cap 120b. The crucible body 120a has a housing space S configured to accommodate the second composition 110. The crucible cap 120b is configured to cover the housing space S. In the method of installing the device 100, the cladding material 130 is configured to coat the first container 120, and the cladding material 130 is not in contact with the second composition 110. The cladding material 130 is, for instance, heat insulation cotton or thermostatic cotton made of alumina or ceramic. The first container 120 coated with the cladding material 130 is then placed into the second container 140, and the second container 140 is, for instance, a beaker. In this way, the device 100 for performing the microwave process can be obtained with reasonable costs.

Step (c2):

the device 100 that has the second composition 110 and is configured for performing the microwave process is placed in a microwave oven to perform the microwave process on the second composition 110. The power of the microwave process can be 200 watts to 1200 watts, and preferably 700 watts. When the power of the microwave process is 700 watts, the time during which the microwave process is performed can be 1 minute to 10 minutes, and preferably 4 minutes. On said conditions of the microwave process (e.g., 700 watts, 4 minutes), the nitrogen-containing compound, the metal-containing compound, and the carbon support can react sufficiently to form a catalyst having a metal-nitrogen-carbon (M-N—C) active site but may not react excessively to break the metal-nitrogen (M-N) bond.

The catalyst synthesized by conducting the preparing method of the catalyst for the fuel cell includes: an iron-urea-carbon (IUC) catalyst, an iron-urea-uric acid-carbon catalyst (IUAC), an iron-uric acid-carbon catalyst (IAC), a cobalt-urea-uric acid-carbon catalyst (CUAC), an iron-cobalt-urea-uric acid-carbon catalyst (ICUAC), an iron-cobalt-urea-carbon (ICUC) catalyst, a cobalt-urea-carbon (CUC) catalyst, or a combination thereof.

For instance, the ICUAC catalyst is synthesized by means of a ferrous ion precursor, a cobalt ion precursor, urea, uric acid, and a carbon support. The ICUAC catalyst has a structure with an iron or cobalt as a center, N as a ligand, and a six-membered ring of the carbon support as the skeleton. In general, the ICUAC catalyst has a nitrogen-containing macrocyclic structure and has an active site of metal-nitrogen-carbon (M-N—C), wherein the active site has an oxygen reduction activity. Besides, in the oxygen reduction reaction, the ICUAC catalyst can reduce the oxygen to water through a migration of 4 electrons.

FIG. 2 is a schematic diagram of a fuel cell membrane electrode assembly according to an embodiment. The membrane electrode assembly 200 includes a separation membrane/polymer membrane 210 in the middle, and the separation membrane/polymer membrane 210 is a proton exchange membrane having proton conductivity. The solid polymer electrolyte material used in the proton exchange membrane is, for instance, a Nafion ionomer membrane. An anode catalyst layer 220a and a cathode catalyst layer 220b are respectively located on the outside of two sides of the separation membrane/polymer membrane 210, and the electrochemical reactions of the anode and the cathode proceed respectively in the two layers. Besides, a diffusion layer 230 (e.g., a gas diffusion layer 230) is located on the outside of the anode catalyst layer 220a and the outside of the cathode catalyst layer 220b, respectively. The anode catalyst material is, for instance, Pt/Pd/carbon powder, and the material of the cathode catalyst includes the catalyst formed by conducting the preparing method of the catalyst for the fuel cell.

The preparing method of the membrane electrode assembly for fuel cell includes the following steps: first, a separation membrane/polymer membrane 210 with proton conductivity is provided; next, an anode catalyst layer 220a and a cathode catalyst layer 220b are farmed respectively at two sides of the separation membrane/polymer membrane 210; then, a diffusion layer 230 (e.g. a gas diffusion layer 230) is formed on the anode catalyst layer 220a and the cathode catalyst layer 220b respectively. It should be noted that, the method of preparing the material of the cathode catalyst includes the preparing method of the catalyst for fuel cell.

In an embodiment, a preparing method of a membrane electrode assembly for a fuel cell includes following steps. A material of an electrode catalyst and the Nafion solution are mixed at a weight ratio of 1:10, so that a catalyst solution is formed. After the catalyst solution is stirred for 24 hours, the catalyst solution is coated onto the diffusion layer (microporous layer, MPL) by means of a scraper, so that a coating layer is formed. The coating layer is dried to form a gas diffusion electrode (i.e., a combination of a diffusion layer and an anode catalyst layer or a combination of a diffusion layer and a cathode catalyst layer). A hot pressing step is performed on the resulted gas diffusion electrode and the separation membrane/polymer membrane. In this way, the membrane electrode assembly for the fuel cell can be obtained.

### Embodiment 1

### Preparing Method of Iron-Urea-Carbon Catalyst

First, 1 g of urea, 200 mg of ferric nitrate (as a precursor of the ferrous ion, i.e., an iron-containing compound), 200 mg of carbon black (model no. BP2000), and 10 mL of ethanol are mixed to form a first composition. Sonication is performed on the first composition for 30 minutes by means of a sonicator. In this way, urea and the ferrous ion generated from the ferric nitrate can be sufficiently dispersed in ethanol. Ethanol in the first composition is removed through reduced pressure concentration (e.g., by means of a rotary evaporator, model no. N2100, manufactured by EYELA), so that a second composition (i.e. dried powder) is obtained. The second composition is put in an ceramic crucible, and the ceramic crucible is put into a beaker, wherein the beaker is filled with heat insulation cotton of alumina in addition to the ceramic crucible. A microwave process is performed on the beaker containing the second composition. The microwave process is performed by means of a household microwave oven (model no.: ST557, manufactured by Matsushita Panasonic, microwave power: 700 W). In the embodiment, the iron-urea-carbon catalyst is synthesized by performing the microwave process for different periods of time (1 minute to 5 minutes), and the effects of the different periods of time on the material properties and the electrochemical properties of the iron-urea-carbon catalyst are observed.

Material Properties of Iron-Urea-Carbon Catalyst

The analysis of X-ray absorption is measured by a beam line 17C1 at the Synchrotron Radiation Center in Hsin Chu, Taiwan. Due to the analysis of X-ray absorption by means of the catalyst, the X-ray near-edge structure (XANES) and the extended X-ray absorption fine structure (EXAFS) of iron may be obtained. The absorption edge jump value of the XANES spectrum of the iron-urea-carbon catalyst synthesized by performing the microwave process for different periods of time (1 minute to 5 minutes) is measured, so that the effects of different periods of time on the oxidation number of iron are obtained. Meanwhile, the EXAFS spectrum of the iron-urea-carbon catalyst synthesized by performing the microwave process for different periods of time (1 minute to 5 minutes) is measured, so that the effects of different periods of time on the coordination environment of iron and on the bond length of iron-nitrogen are obtained.

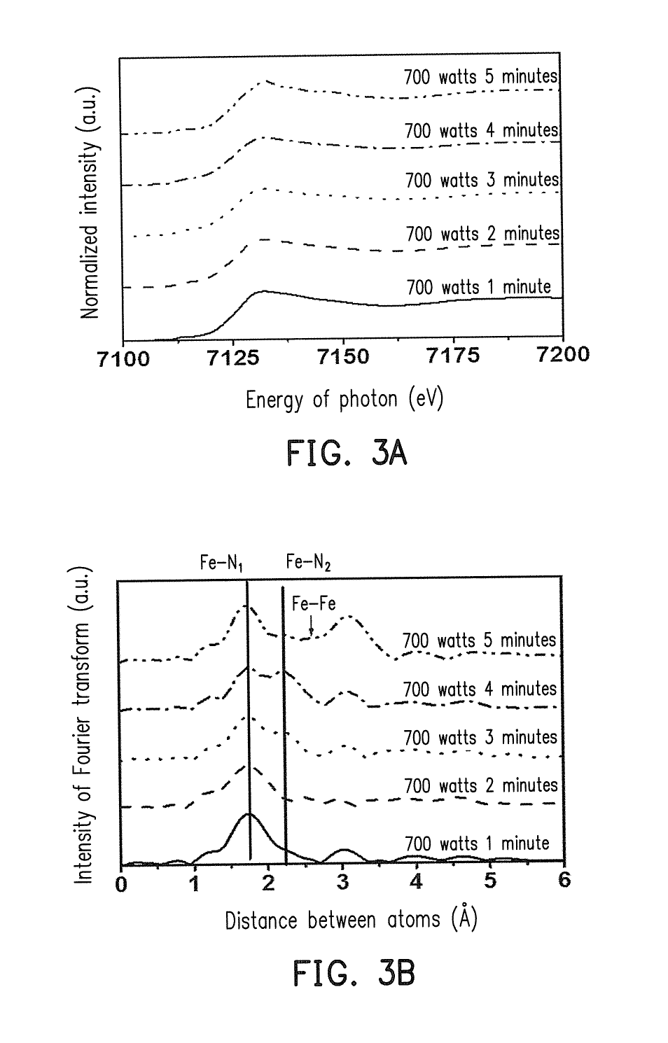

FIG. 3A illustrates an X-ray absorption near edge spectrum of an iron-urea-carbon catalyst synthesized by performing a microwave process for different periods of time. From FIG. 3A, the absorption edge jump value of iron in the iron-urea-carbon catalyst synthesized by performing a microwave process for different periods of time in the XANES spectrum is 7126.1 eV, and therefore the oxidation numbers of the iron in the iron-urea-carbon catalyst synthesized by performing the microwave process for 1 minute to 5 minutes are all +3. Besides, FIG. 3B illustrates an extended X-ray absorption fine structure spectrum of an iron-urea-carbon catalyst synthesized by performing a microwave process for different periods of time, wherein the characteristic peak at 1.76 Å is the Fe—N₁ bond type (with the bond length of 1.76 Å), the characteristic peak at 2.21 Å is the Fe—N₂ bond type (with the bond length of 2.21 Å), and the characteristic peak at 2.63 Å is the Fe—Fe bond type (with the bond length of 2.63 Å). From FIG. 3B, the iron-urea-carbon catalyst synthesized by performing the microwave process time for 1 minute to 2 minutes only has a characteristic peak of 1.76 Å, indicating that the coordination environment of iron is only the Fe—N₁ bond type. In addition, when the period of time during which the microwave process is performed is more than 3 minutes, the synthesized iron-urea-carbon catalyst has a newly emerged characteristic peak of 2.21 Å, indicating that the coordination environment of iron has been changed, and the coordination environment of iron is simultaneously the bond type Fe—N₁ and the bond type Fe—N₂. It should be mentioned that when the period of time during which the microwave process is performed is 4 minutes, the characteristic peak of 2.21 Å is relatively strong, indicating that the ratio of iron of the bond type Fe—N₂ is relatively high. When the iron has the bond type Fe—N₂, the reduction activity of the catalyst is high. Besides, when the period of time during which the microwave process is performed is 5 minutes, the characteristic peak of bond type Fe—Fe (with the bond length of 2.63 Å) has emerged, indicating that the iron-nitrogen bond in the iron-urea-carbon catalyst has been broken, and an iron-iron bond has been formed, so that the reduction ability of the iron-urea-carbon catalyst is decreased.

Next, the X-ray powder diffraction spectrum of the iron-urea-carbon catalyst synthesized by performing the microwave process for different periods of time (1 minute to 5 minutes) is measured to obtain a structure change of the iron-urea-carbon catalyst. The model no. of the X-ray powder diffraction machine D2 phaser, the X-ray powder diffraction machine is manufactured by Bruker, and a wavelength of the light source is 1.54056 Å.

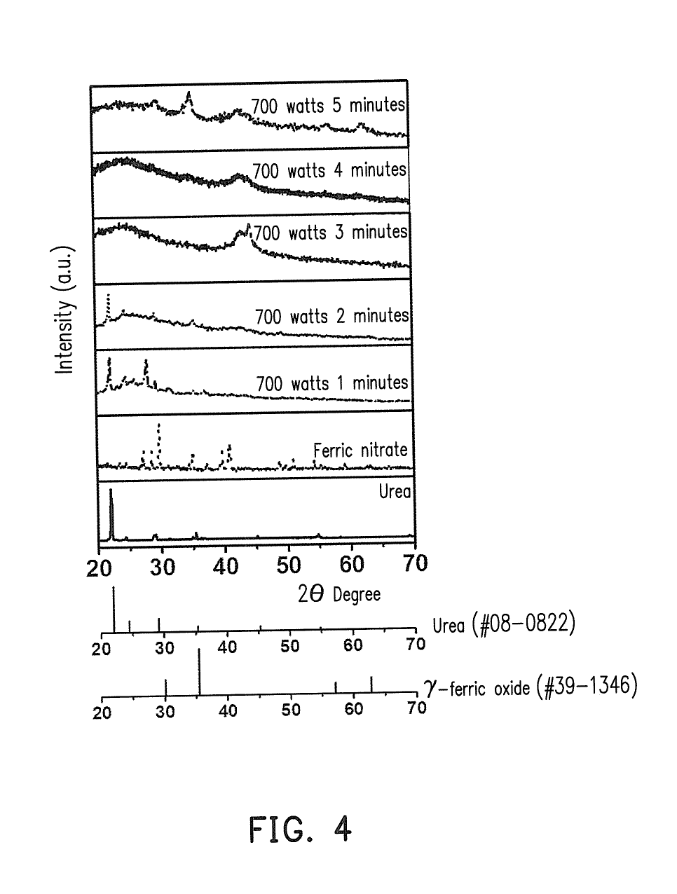

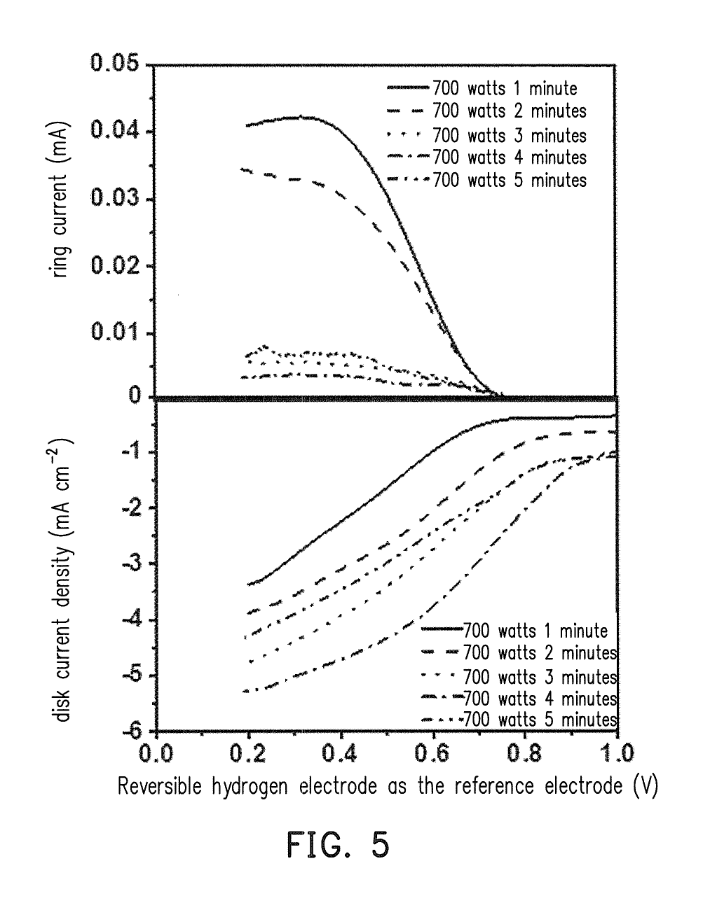

FIG. 4 is an X-ray powder diffraction spectrum of an iron-urea-carbon catalyst, urea, and ferric nitrate synthesized by performing a microwave process for different periods of time. According to the X-ray diffraction database, the characteristic peak at 22.5 degrees is from urea, wherein the serial number of urea in the X-ray database is #08-0822. According to the X-ray diffraction database, the characteristic peaks at 29.94, 43.17, 57.05, and 62.41 degrees are from γ-ferric oxide, wherein the serial number of γ-ferric oxide in the X-ray database is #39-1346. From FIG. 5, the iron-urea-carbon catalyst synthesized by performing the microwave process for 1 minute to 2 minutes has a 22.5-degree characteristic peak from urea. It can therefore be deduced that urea and ferric nitrate have not fully reacted to from an iron-nitrogen bond. Besides, the iron-urea-carbon catalyst synthesized by performing the microwave process for 3 minutes to 4 minutes does not have the 22.5-degree characteristic peak from urea. It can be deduced that urea and ferric nitrate have fully reacted and form an iron-nitrogen bond. On the other hand, the iron-urea-carbon catalyst synthesized by performing the microwave process for 5 minutes has characteristic peaks at 29.94, 43.17, 57.05, and 62.41 degrees from γ-ferric oxide. It can be deduced that the iron-nitrogen bond in the iron-urea-carbon catalyst has been broken, and the iron-iron and iron-oxygen bonds have been formed. In sum, the experimental results of the X-ray absorption fine structure spectrum and the X-ray powder diffraction spectrum are substantially the same.

Evaluation of Electrochemical Property of Iron-Urea-Carbon Catalyst

The oxygen reduction ability of the iron-urea-carbon catalyst synthesized by performing a microwave process for different periods of time of 1 minute to 5 minutes is measured, and the measuring method is described below. A rotating ring-disk electrode is used, and linear sweep voltammetry is performed in a oxygen-saturated 0.1 M perchloric acid solution. The potential is from −0.2 V to 0.8 V. The reference electrode is a saturated calomel electrode (SCE, Hg/Hg₂Cl₂/KCl). The apparatus used is a potentiostat that has the model no. VSP and is manufactured by Biologic.

FIG. 5 is a diagram illustrating oxygen reduction ability of an iron-urea-carbon catalyst synthesized by performing a microwave process for different periods of time. In detail, FIG. 5 is a diagram illustrating the relationship between the disk current density (I_{d}) and the applied voltage and the relationship between the ring current (Iᵣ) and the applied voltage, wherein the saturated calomel electrode serves as a comparison standard for the applied voltage, and the applied voltage is further converted to a reference voltage in which a reversible hydrogen electrode is used, so as to be compared with those provided in other literatures. According to FIG. 5, the maximum of the absolute value of the disk current density (I_{d}) and the minimum of the absolute value of the ring current (Iᵣ) are taken to calculate the total electron transfer number n by formula (1), and formula (2) is applied to calculate the productivity of hydrogen peroxide (% H₂O₂). In formula (1) and formula (2), N represents the collection efficiency of the rotating ring disk electrode.

$$\begin{matrix}n = \frac{4 {I}_{d}}{{I}_{d} + \frac{{I}_{r}}{N}} & formula ( 1 ) \\ \% {H}_{2} {O}_{2} = \frac{\frac{2 {I}_{r}}{N}}{{I}_{d} + \frac{{I}_{r}}{N}} & formula ( 2 )\end{matrix}$$

The greater the total electron transfer number of n, the better the efficiency of reducing the oxygen by the iron-urea-carbon catalyst. The higher the productivity of hydrogen peroxide (% H₂O₂), the greater the amount of oxygen reduced into hydrogen peroxide, which is not favorable. The total electron transfer number n and the productivity of the hydrogen peroxide (% H₂O₂) of the iron-urea-carbon catalyst synthesized by performing a microwave process for different periods of time are shown in Table 1. As indicated in Table 1, the total electron transfer number n of the iron-urea-carbon catalyst synthesized by performing the microwave process for 4 minutes is large, and the productivity of hydrogen peroxide (% H₂O₂) of the said catalyst is low. By contrast, the total electron transfer number n of the iron-urea-carbon catalyst synthesized by performing the microwave process for 5 minutes is small. Specifically, since the iron-nitrogen bond in the iron-urea-carbon catalyst has been broken to form an iron-iron bond, the reduction ability of the iron-urea-carbon catalyst is decreased.

TABLE 1

| | | Total | Productivity |
|---|---|---|---|
| | | Electron Transfer | of Hydrogen |
| | | Number n | Peroxide (% H₂O₂) |
| The time for performing | 1 | 3.52 | 24.0% |
| the microwave process to | 2 | 3.64 | 16.0% |
| synthesize the | 3 | 3.94 | 3.0% |
| (iron-urea-carbon) | 4 | 3.97 | 1.5% |
| catalyst | 5 | 3.92 | 4.0% |
| (minute) | | | |

Next, the iron-urea-carbon catalyst is applied in the cathode catalyst of a proton exchange membrane fuel cell (PEMFC), and a polarization curve of the full cell is measured. In detail, the membrane electrode assembly is prepared by applying the preparing method of the membrane electrode assembly. A graphite plate having a channel design and a metal plate are then sequentially disposed at two sides of the membrane electrode assembly. The membrane electrode assembly, the graphite plate, and the metal plate are fixed with screws and measured by a battery test set (model no.: FCED-P 200, manufactured by Asia fuel cell).

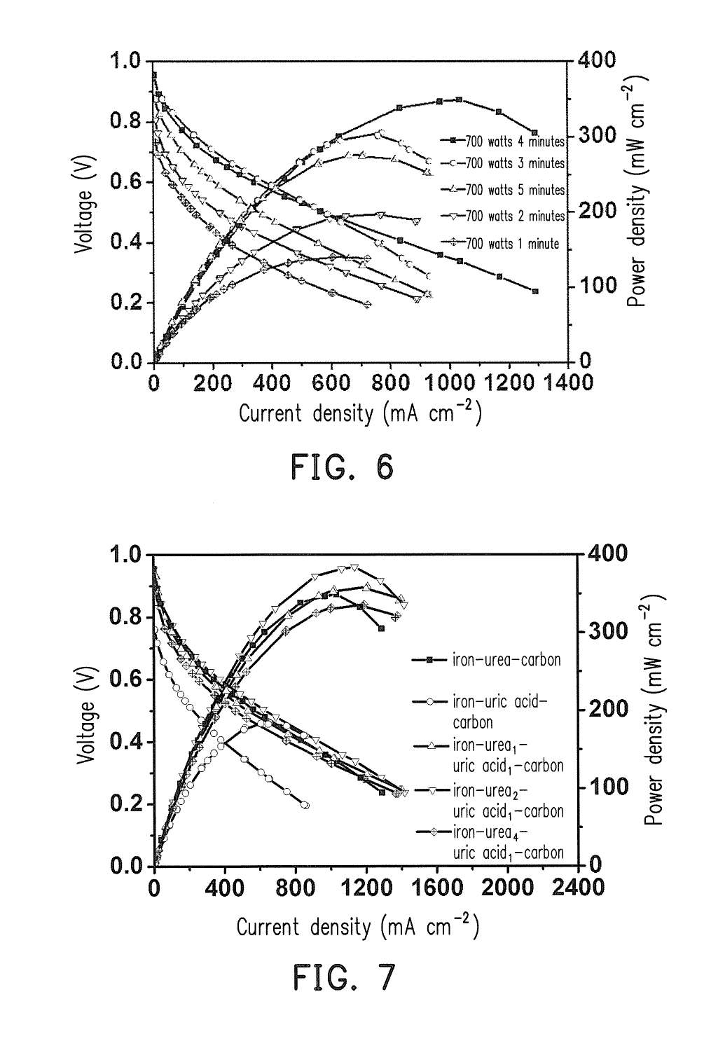

FIG. 6 is a polarization curve diagram illustrating that an iron-urea-carbon catalyst synthesized by performing a microwave process for different periods of time is applied as a cathode catalyst of a PEMFC. From FIG. 6, the open circuit voltage (OCV) of the iron-urea-carbon catalyst synthesized by performing the microwave process for 4 minutes is 0.95 V, and the power density is 395 mWcm⁻².

### Embodiment 2

### Preparing Method of Iron-Urea-Uric Acid-Carbon Catalyst, Iron-Urea-Carbon Catalyst, and Iron-Uric Acid-Carbon Catalyst

The iron-urea-uric acid-carbon catalyst, the iron-urea-carbon catalyst, and the iron-uric acid-carbon catalyst described in embodiment 2 are prepared by performing the same steps as those described in embodiment 1, and the difference therebetween lies in that uric acid is added, and that the weight ratio of urea to uric acid is changed. Specifically, the raw materials of the iron-urea-uric acid-carbon catalyst, the iron-urea-carbon catalyst, and the iron-uric acid-carbon catalyst provided in embodiment 2 are urea, uric acid, 200 mg of ferric nitrate, 200 mg of carbon black (model no.: BP2000), and ethanol, among which the usage quantity of urea is respectively 0 mg or 1 g, and the usage quantity of uric acid is respectively 0 mg, 250 mg, 500 mg, or 1 g. When the usage quantity of urea is 1 g, and the usage quantity of uric acid is 250 mg, the weight ratio of urea to uric acid is 4:1, and the synthesized catalyst is called an iron-urea₄-uric acid₁-carbon catalyst. When the usage quantity of urea is 1 g, and the usage quantity of uric acid is 500 mg, the weight ratio of urea to uric acid is 2:1, and the synthesized catalyst is called an iron-urea₂-uric acid₁-carbon catalyst. When the usage quantity of urea is 1 g, and the usage quantity of uric acid is 1 g, the weight ratio of urea to uric acid is 1:1, and the synthesized catalyst is called an iron-urea₁-uric acid₁-carbon catalyst. When the usage quantity of urea is 1 g, and the usage quantity of uric acid is 0 mg, the weight ratio of urea to uric acid is 1:0, and the synthesized catalyst is called an iron-urea-carbon catalyst. When the usage quantity of urea is 0 g, and the usage quantity of uric acid is 1 g, the weight ratio of urea to uric acid is 0:1, and the synthesized catalyst is called an iron-uric acid-carbon catalyst.

Said catalyst is applied as a cathode catalyst of a PEMFC via the same method as the method in embodiment 1, and the polarization curve of the full cell is measured. FIG. 7 is a polarization curve diagram illustrating that an iron-urea-carbon catalyst, an iron-urea-uric acid-carbon catalyst, and an iron-uric acid-carbon catalyst are applied as a cathode catalyst of a PEMFC, and the iron-urea-carbon catalyst, the iron-urea-uric acid-carbon catalyst, and the iron-uric acid-carbon catalyst are synthesized at different weight ratios of urea and uric acid. As shown in FIG. 7, when the iron-urea₂-uric acid₁-carbon catalyst acts as the catalyst described herein, the resultant PEMFC achieves favorable effects. Specifically, the open voltage of the iron-urea₂-uric acid1-carbon catalyst is 0.98 V, and the power density is 382 mWcm⁻².

### Embodiment 3

### Preparing Method of Iron-Urea-Uric Acid-Carbon Catalyst, Cobalt-Urea-Uric Acid-Carbon Catalyst, and Iron-Cobalt-Urea-Uric Acid-Carbon Catalyst

The iron-urea-uric acid-carbon catalyst, the cobalt-urea-uric acid-carbon catalyst, and the iron-cobalt-urea-uric acid-carbon catalyst described in embodiment 3 are prepared by performing the same steps as those provided in embodiment 1, and the difference therebetween lies in that cobalt nitrate (as a precursor of cobalt ion, i.e., a cobalt-containing compound) is added, and that the atom ratio of iron to cobalt is varied. Specifically, the raw materials of the iron-urea-uric acid-carbon catalyst described in embodiment 3 are 1 g of urea, 500 mg of uric acid, ferric nitrate, cobalt nitrate, 200 mg of carbon black (model no.: BP2000), and ethanol. In the embodiment, the usage quantity of ferric nitrate is respectively 117.6 mg, 148.2 mg, 170.2 mg, and 200 mg, and the usage quantity of cobalt nitrate is respectively 82.4 mg, 51.8 mg, 29.8 mg, and 200 mg.

When the usage quantity of ferric nitrate is 170.2 mg, and the usage quantity of cobalt nitrate is 29.8 mg, the atom ratio of iron to cobalt is 4:1, and the synthesized catalyst is called an iron₄-cobalt₁-urea₂-uric acid₁-carbon catalyst. When the usage quantity of ferric nitrate is 148.2 mg, and the usage quantity of cobalt nitrate is 51.8 mg, the atom ratio of iron to cobalt is 2:1, and the synthesized catalyst is called an iron₂-cobalt₁-urea₂-uric acid₁-carbon catalyst. When the usage quantity of ferric nitrate is 117.6 mg, and the usage quantity of cobalt nitrate is 82.4 mg, the atom ratio of iron to cobalt is 1:1, and the synthesized catalyst is called an iron₁-cobalt₁-urea₂-uric acid₁-carbon catalyst. When the usage quantity of ferric nitrate is 0 mg, and the usage quantity of cobalt nitrate is 200 mg, the atom ratio of iron to cobalt is 0:1, and the synthesized catalyst is called a cobalt-urea₂-uric acid₁-carboncatalyst. When the usage quantity of ferric nitrate is 200 mg, and the usage quantity of cobalt nitrate is 0 mg, the atom ratio of iron to cobalt is 1:0, and the synthesized catalyst is called an iron-urea₂-uric acid₁-carbon catalyst.

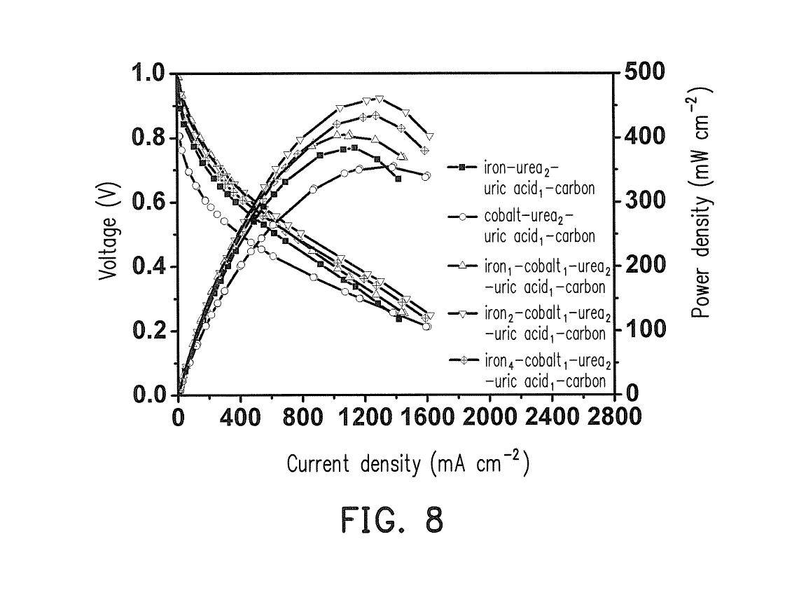

Said catalyst is applied as the cathode catalyst of a PEMFC via the same method as that described in embodiment 1, and the polarization curve of the full cell is measured. FIG. 8 is a polarization curve diagram illustrating that an iron-urea-uric acid-carbon catalyst, a cobalt-urea-uric acid-carbon catalyst, and an iron-cobalt-urea-uric acid-carbon catalyst are applied as a cathode catalyst of a PEMFC, and the iron-urea-uric acid-carbon catalyst, the cobalt-urea-uric acid-carbon catalyst, and the iron-cobalt-urea-uric acid-carbon catalyst are synthesized at different weight ratios of iron and cobalt. Said catalysts are synthesized at different weight ratios of iron to cobalt. When the iron₂-cobalt₁-urea₂-uric acid₁-carbon catalyst is applied as a catalyst, the resultant PEMFC achieves favorable effects. Specifically, the open voltage of the iron₂-cobalt₁-urea₂-uric acid₁-carbon catalyst is 1.00 V, and the power density is 461 mWcm⁻².

In sum, according to an embodiment of the invention, the first composition is formed by mixing the nitrogen-containing compound (e.g., urea and/or uric acid), the metal-containing compound (e.g., the iron-containing compound and the cobalt-containing compound), the carbon support, and the environmentally-friendly solvent. such as ethanol. Moreover, after the removal of the solvent from the first composition, the microwave process is performed on certain conditions on the second composition to form a catalyst. As a result, the raw material costs of synthesizing the catalyst can be lowered down significantly, the time for synthesizing the catalyst for the fuel cell can be shortened, and the ratio of the composition can be more readily controlled. Additionally, the catalyst for the fuel cell synthesized by applying said method is also characterized by superior oxygen reduction ability.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A preparing method of a catalyst for a fuel cell, the preparing method comprising:
mixing a nitrogen-containing compound, a metal-containing compound, a carbon support, and a solvent to form a first composition, such that the nitrogen-containing compound and the metal-containing compound are dispersed in the solvent;
removing the solvent in the first composition to form a second composition; and
performing a microwave process on the second composition.

2. The preparing method according to claim 1, wherein the nitrogen-containing compound comprises urea, uric acid, or a combination thereof.

3. The preparing method according to claim 1, wherein the metal-containing compound comprises an iron-containing compound, a cobalt-containing compound, or a combination thereof.

4. The preparing method according to claim 1, wherein the carbon support comprises a carbon nanotube, a carbon black or graphene, or a combination thereof.

5. The preparing method according to claim 1, wherein the solvent comprises an alcohol solvent, water, or a combination thereof.

6. The preparing method according to claim 1, wherein the step of performing the microwave process on the second composition comprises:
putting the second composition in a container,
coating the container with a cladding material, wherein the cladding material is not in contact with the second composition; and
performing the microwave process on the second composition.

7. A preparing method of a membrane electrode assembly for a fuel cell, the method comprising:
providing a polymer membrane with proton conductivity;
forming a cathode catalyst layer and an anode catalyst layer at two sides of the polymer membrane, respectively, wherein a preparing method of the cathode catalyst layer comprises:
mixing a nitrogen-containing compound, a metal-containing compound, a carbon support, and a solvent to form a first composition, such that the nitrogen-containing compound and the metal-containing compound are dispersed in the solvent;
removing the solvent in the first composition to form a second composition; and
performing a microwave process on the second composition; and
forming a diffusion layer on the cathode catalyst layer and the anode catalyst layer, respectively.
